(19) United States
(12) Patent Application Publication
(10) Pub. No.: US 2010/0113012 A1
(43) Pub. Date: May 6, 2010

(54) SYSTEM AND METHOD FOR IDENTIFYING STATUS OF A MOBILE PHONE

(75) Inventor: CHIA-HUNG CHIU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/549,495

(22) Filed: Aug. 28, 2009

(30) Foreign Application Priority Data
Oct. 31, 2008 (CN) 200810305327.4

(51) Int. Cl. H04W 24/00

(52) U.S. Cl. 455/425

(57) ABSTRACT

A system and method for identifying status of a mobile phone set an allowable settle time of a SIM card of the mobile phone corresponding to a region of each base station, and setting warning information and a notification number to receive the warning information if the mobile phone is identified as being in a lost status. The system and method further determines if a settle time of the SIM card in the mobile phone reaches the allowable settle time, and identifies the mobile phone is being in the lost status if the settle time of the SIM card in the mobile phone reaches the allowable settle time, and sends the warning information to the notification number through the base station.

### BACKGROUND

1. Technical Field

Embodiments of the present disclosure relate to an identifying system, and more particularly to a system and method for identifying status of a mobile phone.

2. Description of Related Art

Mobile phones have many advanced functions and auxiliary functions. The auxiliary functions of the mobile phones typically include a phone book system, ring tones, network settings, short message services, and reproducing media files. However, mobile phones are easily lost. Once the mobile phones are lost or stolen, it is difficult to find the mobile phones.

What is needed, therefore, is an improved system and method for identifying status of a mobile phone.

### BRIEF DESCRIPTION OF THE DRAWINGS

FIG. 1 is a block diagram of one embodiment of a mobile phone in communication with a plurality of electronic devices through a plurality of base stations.

FIG. 2 is a block diagram of one embodiment of the mobile phone comprising an identifying system.

FIG. 3 is a flowchart of one embodiment of a method for identifying status of the mobile phone.

FIG. 4 is a schematic diagram of one embodiment of a distribution of base stations.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

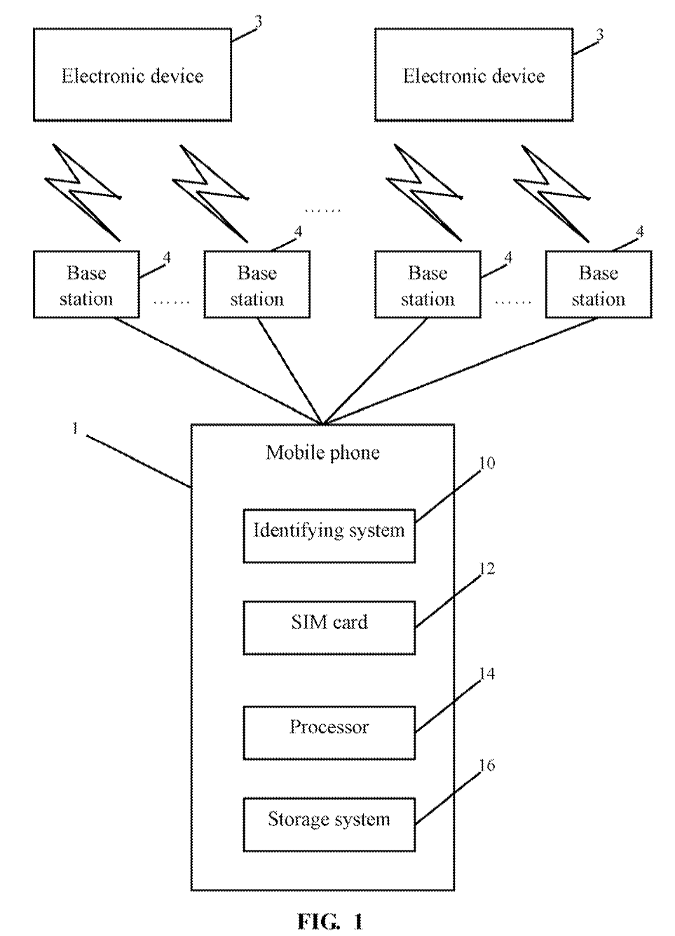

FIG. 1 is a block diagram of one embodiment of a mobile phone 1 in communication with a plurality of electronic devices 3 through a plurality of base stations 4. The mobile phone 1 includes an identifying system 10 operable to identify a status of the mobile phone 1. In one embodiment, if the mobile phone 1 has been lost, then the identifying system 10 may identify that the mobile phone 1 is in a lost status and sends warning information to the plurality of electronic devices 3 via the plurality of base stations 4. In one embodiment, the identifying system 10 is included in a computer readable medium or an operating system of the mobile phone 1.

The mobile phone 1 may include a subscriber identity module (SIM) card 12, a processor 14, and a storage system 16.

The processor 14 executes one or more computerized operations of the mobile phone 1 and other applications, to provide functions of the mobile phone 1. The storage system 16 stores one or more programs, such as programs of an operating system, other applications of the mobile phone 1, and various kinds of data, such as the warning information, for example. In one embodiment, the storage system 16 may include a hard disk of the mobile phone 1.

In one embodiment, the plurality of base stations 4 may be wireless base stations or mobile telephone base stations, for example. Each base station 4 emits radio signals periodically, and each electronic device 3 within a range of each base station 4 may identify a nearest base station 4 after receiving the radio signals. The plurality of electronic devices 3 may be mobile phones, personal digital assistants (PDAs), or any other kind of computing device, for example. The plurality of electronic devices 3 may receive the warning information from the mobile phone 1 through the plurality of base stations 4 to determine that the mobile phone 1 is being in the lost status.

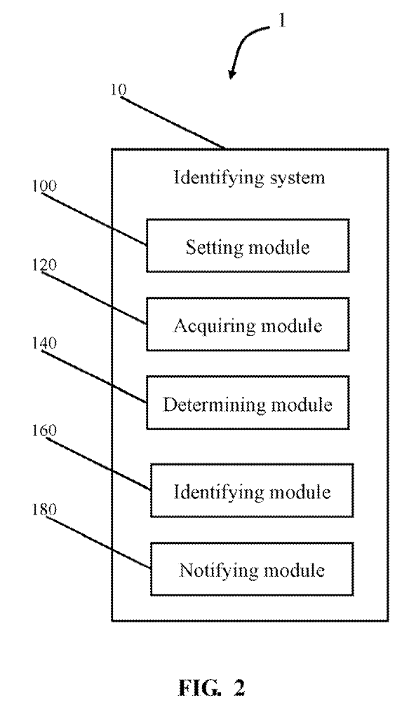

FIG. 2 is a block diagram of one embodiment of the mobile phone 1 comprising the identifying system 10. In one embodiment, the identifying system 10 includes a setting module 100, an acquiring module 120, a determining module 140, an identifying module 160, and a notifying module 180. The modules 100-180 may comprise one or more computerized operations to be executed by the processor 14 to perform one or more operations of the mobile phone 1, to identify if the mobile phone 1 is being in the lost status, and send the warning information to the plurality of electronic devices 3.

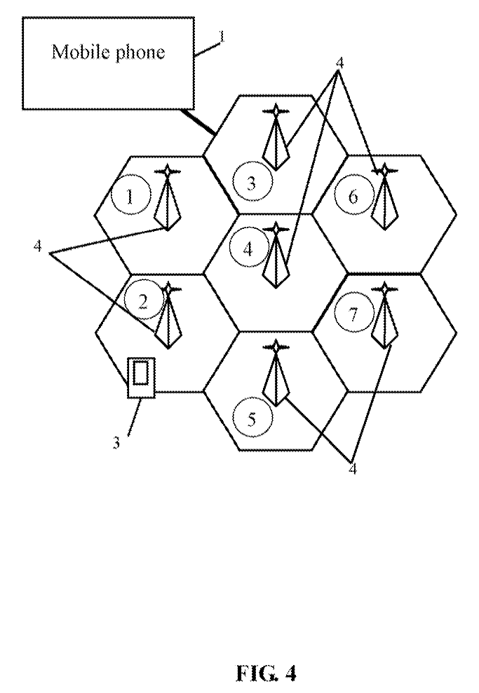

The setting module 100 partitions a region for each of the plurality of base stations 4 according to distribution ranges of the plurality of base stations 4 and a cover region of radio signals of each of the plurality of base station 4. For example, if a city has 100 base stations, then the city may be divided into 100 regions. The setting module 100 further assigns an identification (ID) number for each of the plurality of base stations 4. Referring to FIG. 4, the distribution ranges of the plurality of base stations 4 and the region of each of the plurality of base stations 4 are shown. As shown, the electronic device 3 is connected to the mobile phone 1 through a base station 4 having an ID number “3.” In one embodiment, the ID number of each of the plurality of base stations 4 may be numerical, or alphanumerical, for example.

The setting module 100 sets an allowable settle time of the SIM card 12 of the mobile phone 1 corresponding to the region of each base station 4. In one embodiment, the settle time of the SIM card 12 is the time that the SIM card 12 spends in a region of a base station 4 before moving to another base station. The setting module 100 also sets warning information and a notification number to receive the warning information if the mobile phone 1 is identified as being potentially missing. For example, the setting module 100 may set the allowable settle time as “3 hours” corresponding to the region of the base station 4 having an ID number “6.” In one embodiment, the allowable settle time may be set according to user habits or appearance frequency in the region of the base station 4 on some regions of the base station 4. The notification number may be a phone number of the electronic device 3, for example.

The acquiring module 120 acquires an ID number of a base station 4 when the mobile phone 1 is in the region of the base station 4, and determines a region corresponding to the base station 4.

The determining module 140 determines if a settle time of the mobile phone 1 in the region of the base station 4 reaches the allowable settle time.

The identifying module 160 identifies the mobile phone 1 is being in the lost status if the settle time of the SIM card 12 in the region of the base station 4 reaches the allowable settle time. Then, the notifying module 180 sends the warning information to the notification number to signal the electronic device 3 that the mobile phone 1 is in a lost status. In one embodiment, the warning information may be sent in a message (e.g., short message service (SMS) or an e-mail format.

In another embodiment, the setting module 100 may further set an allowable use time of a new SIM card in the mobile phone 1. The acquiring module 120 may set original IMSI data of the SIM card 12, and acquire an international mobile subscriber identity (IMSI) data of a current SIM card. The determining module 140 determines if the acquired IMSI data is the same as the original IMSI data. The acquiring module 120 is further operable to acquire the ID number of the base station if the acquired IMSI data is the same as the original IMSI data, and the determining module 140 determines if a use time of the current SIM card reaches the allowable use time if the acquired IMSI data is not the same as the original IMSI data. When the usage time of the current SIM card reaches the allowable use time, then the mobile phone 1 is identified as being in the lost status and may send warning information to one of the electronic device 3.

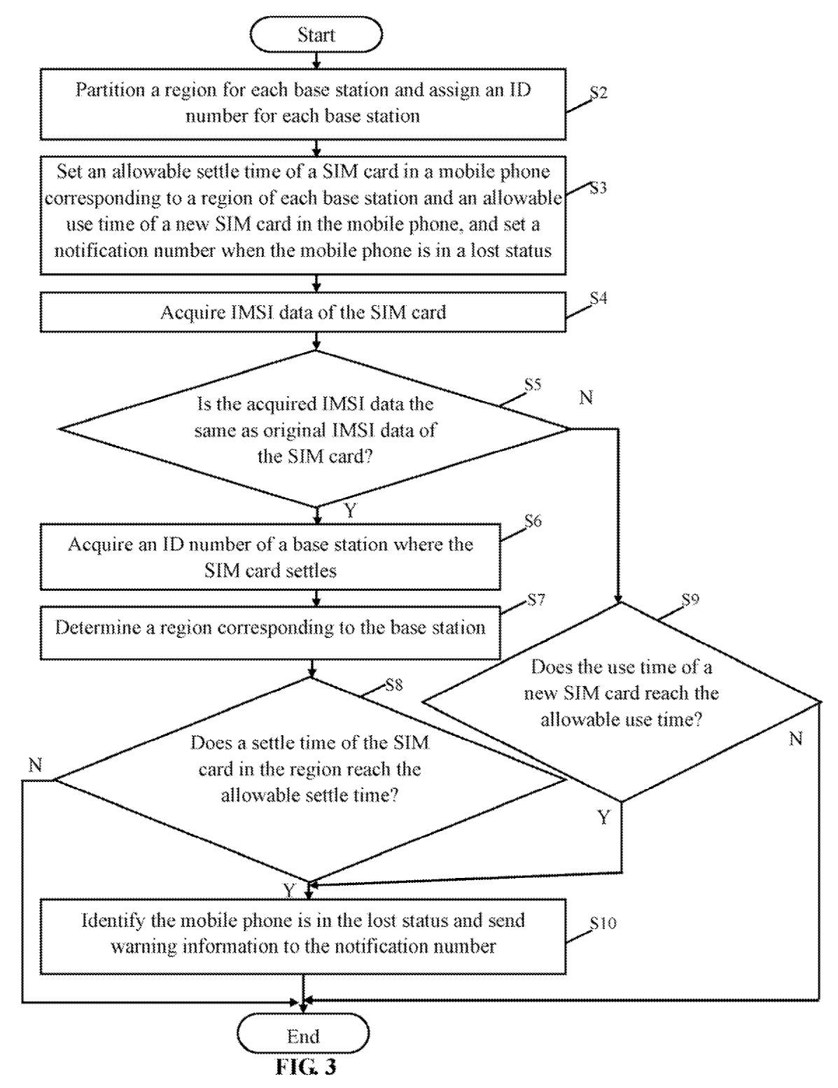

FIG. 3 is a flowchart of one embodiment of a method for identifying status of mobile phone 1. Depending on the embodiment, additional blocks may be added, others removed, and the ordering of the blocks may be replaced.

In block S2, the setting module 100 partitions a region for each of the plurality of base stations 4 according to distribution ranges of the plurality of base stations 4 and a cover region of radio signals of each of the plurality of base stations 4, and assigns an ID number for each of the plurality of base stations 4.

In block S3, the setting module 100 sets the allowable settle time of the SIM card 12 of the mobile phone 1 corresponding to the region of each base station, and sets warning information and the notification number to receive the warning information if the mobile phone 1 is identified as being in the lost status. For example, the setting module 100 may set the allowable settle time as “3 hour” corresponding to the region of the base station 4 having an ID number “6.” In one embodiment, the allowable settle time may be set according to user life habits or appearance frequency in some region of the base station 4. The setting module 100 further sets an allowable use time of a new SIM card in the mobile phone 1. For example, the setting module 100 set the allowable use time as “15 minutes”, that is, the mobile phone 1 is identified as being in the lost status when the use time of the new SIM card reaches 15 minutes. Further, the setting module 100 sets original IMSI data of the SIM card 12 of the mobile phone 1.

In block S4, the acquiring module 120 acquires the IMSI data of a current SIM card.

In block S5, the determining module 140 determines if the acquired IMSI data is the same as the original IMSI data of the SIM card 12.

In block S6, the acquiring module 120 acquires the ID number of a base station 4 where the SIM card 12 settles if the acquired IMSI data is the same as the original IMSI data, and otherwise, the procedure goes to block S9.

In block S7, the acquiring module 120 determines the region corresponding to the base station 4 according to the acquired ID number.

In block S8, the determining module 140 determines if the settle time of the SIM card 12 in the region reaches the allowable settle time. If the settle time of the SIM card 12 in the region reaches the allowable settle time, in block S10, the identifying module 160 identifies the mobile phone 1 is being in the lost status. And the notifying module 180 sends the warning information to the notification number to tell the mobile phone 1 is being in the lost status. Otherwise, if the settle time of the SIM card in the region does not reach the allowable settle time, the procedure goes ends.

In block S5, if the acquired IMSI data is not same as the original IMSI data of the SIM card, the procedure goes to block S8 to determine if the use time of the new SIM card reaches the allowable use time. If the use time of the new SIM card reaches the allowable use time, the procedure goes to block S10, otherwise, if the use time of the new SIM card does not reach the allowable use time, the procedure goes ends.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for identifying status of a mobile phone, the mobile phone being installed with a subscriber identity module (SIM) card, the method comprising:
(a) partitioning a region for each of a plurality of base stations, and assigning an identification (ID) number for each base station;
(b) setting an allowable settle time of the SIM card of the mobile phone, the settle time of the SIM card corresponding to a region of each base station, and setting warning information and a notification number to receive the warning information if the mobile phone is identified as being in a lost status;
(c) acquiring an ID number of a base station when the mobile phone is in the region of the base station;
(d) determining if a settle time of the SIM card in the mobile phone reaches the allowable settle time; and
(e) identifying the mobile phone is being in the lost status if the settle time of the SIM card in the mobile phone reaches the allowable settle time, and sending the warning information to the notification number through the base station.

2. The method according to claim 1, wherein the warning information is sent to the notification number in a message or an e-mail format.

3. The method according to claim 1, wherein the plurality of base stations are wireless base stations or mobile telephone base stations.

4. The method according to claim 1, wherein the ID number of each base station may be numerical or alphanumerical.

5. The method according to claim 1, wherein the step (b) comprises:
setting an allowable use time of a new SIM card in the mobile phone.

6. The method according to claim 5, further comprising:
setting original IMSI data of the SIM card of the mobile phone;
acquiring an international mobile subscriber identity (IMSI) data of a current SIM card;
determining if the acquired IMSI data is the same as the original IMSI data;
acquiring the ID number of the base station if the acquired IMSI data is the same as the original IMSI data; or
determining if a use time of the current SIM card reaches the allowable use time if the acquired IMSI data is not the same as the original IMSI data, and executing step (e) if the use time of the current SIM card reaches the allowable use time.

7. A computing system for identifying status of a mobile phone, the mobile phone being installed with a subscriber identity module (SIM) card, the computing system comprising:
a storage system;
at least one processor; and
one or more programs stored in the storage system and being executable by the at least one processor, the one or more programs comprising:
a setting module operable to partition a region for each of a plurality of base stations, and assigning an identification (ID) number for each base station;
the setting module further operable to set an allowable settle time of the SIM card of the mobile phone, the settle time of the SIM card corresponding to a region of each base station, and set warning information and a notification number to receive the warning information if the mobile phone is identified as being in a lost status;
an acquiring module operable to acquire an ID number of a base station when the mobile phone is in the region of the base station; and
a determining module operable to determine if a settle time of the SIM card in the mobile phone reaches the allowable settle time;
an identifying module operable to identify the mobile phone is being in the lost status if the settle time of the SIM card in the region reaches the allowable settle time; and
a notifying module operable to send the warning information to the notification number through the base station.

8. The computing system according to claim 7, wherein the warning information is sent to the notification number in a message or an e-mail format.

9. The computing system according to claim 7, wherein the plurality of base stations are wireless base stations or mobile telephone base stations.

10. The computing system according to claim 7, wherein the ID number of each base station may be numerical or alphanumerical.

11. The computing system according to claim 7, wherein the setting module is further operable to set an allowable use time of a new SIM card in the mobile phone.

12. The computing system according to claim 11, wherein:
the setting module is further operable to set original IMSI data of the SIM card of the mobile phone;
the acquiring module is further operable to acquire an international mobile subscriber identity (IMSI) data of a current SIM card;
the determining module is further operable to determine if the acquired IMSI data is the same as the original IMSI data;
the acquiring module is further operable to acquire the ID number of the base station if the acquired IMSI data is the same as the original IMSI data; and
the determining module is further operable to determine if a use time of the current SIM card reaches the allowable use time if the acquired IMSI data is not the same as the original IMSI data.

13. A storage medium storing a set of instructions, the set of instructions capable of being executed by a processor to perform a method for identifying status of a mobile phone, the mobile phone being installed with a subscriber identity module (SIM) card, the method comprising:
(a) partitioning a region for each of a plurality of base stations, and assigning an identification (ID) number for each base station;
(b) setting an allowable settle time of the SIM card of the mobile phone, the settle time of the SIM card corresponding to a region of each base station, and set warning information and a notification number to receive the warning information if the mobile phone is identified as being in a lost status;
(c) acquiring an ID number of a base station when the mobile phone is in the region of the base station;
(d) determining if a settle time of the SIM card in the mobile phone reaches the allowable settle time; and
(e) identifying the mobile phone is being in the lost status if the settle time of the SIM card in the mobile phone reaches the allowable settle time, and sending the warning information to the notification number through the base station.

14. The storage medium as claimed in claim 13, wherein the warning information is sent to the notification number in a message or an e-mail format.

15. The storage medium as claimed in claim 13, wherein the plurality of base stations are wireless base stations or mobile telephone base stations.

16. The storage medium according to claim 13, wherein the ID number of each base station may be numerical or alphanumerical.

17. The storage medium according to claim 13, wherein the block (b) comprises:
setting an allowable use time of a new SIM card in the mobile phone.

18. The storage medium according to claim 17, further comprising:
setting original IMSI data of the SIM card of the mobile phone;
acquiring an international mobile subscriber identity (IMSI) data of a current SIM card;
determining if the acquired IMSI data is the same as original IMSI data;
acquiring the ID number of the base station if the acquired IMSI data is the same as the original IMSI data;
determining if a use time of the current SIM card reaches the allowable use time if the acquired IMSI data is not the same as the original IMSI data; and
going to the block (e) if the use time of the current SIM card reaches the allowable use time.
